(19) United States
(12) Patent Application Publication
(10) Pub. No.: US 2013/0275632 A1
(43) Pub. Date: Oct. 17, 2013

(54) KEY DETECTION CIRCUIT

(71) Applicants: Lu-Qing MENG, Shenzhen City (CN); Hsing-Suang KAO, Tu-Cheng (TW); Chun-Lung HUNG, Tu-Cheng (TW)

(72) Inventors: Lu-Qing MENG, Shenzhen City (CN); Hsing-Suang KAO, Tu-Cheng (TW); Chun-Lung HUNG, Tu-Cheng (TW)

(73) Assignees: HON HAI PRECISION INDUSTRY CO., LTD., Tu-Cheng (TW); HONG FU JIN PRECISION INDUSTRY (ShenZhen) CO. LTD., Shenzhen City (CN)

(21) Appl. No.: 13/527,949

(22) Filed: Jun. 20, 2012

(30) Foreign Application Priority Data
Apr. 16, 2012 (CN) 201210109993.7

(51) Int. Cl. G06F 3/00

(52) U.S. Cl. 710/38

(57) ABSTRACT

An exemplary key detection circuit is provided. The key detection circuit includes a number of key pins, a number of switches, and a number of general purpose input/output (GPIO) interfaces. The switches include a first group of switches and a second group of switches. Each one of the first group of switches is connected to one of the key pins, and each one of the second group of switches is connected to two key pins. Each GPIO interface corresponds to one key pin, one GPIO interface is set to receive input voltages which alternate between a high level and a low level, the other GPIO interfaces are set to receive a fixed level voltage input.

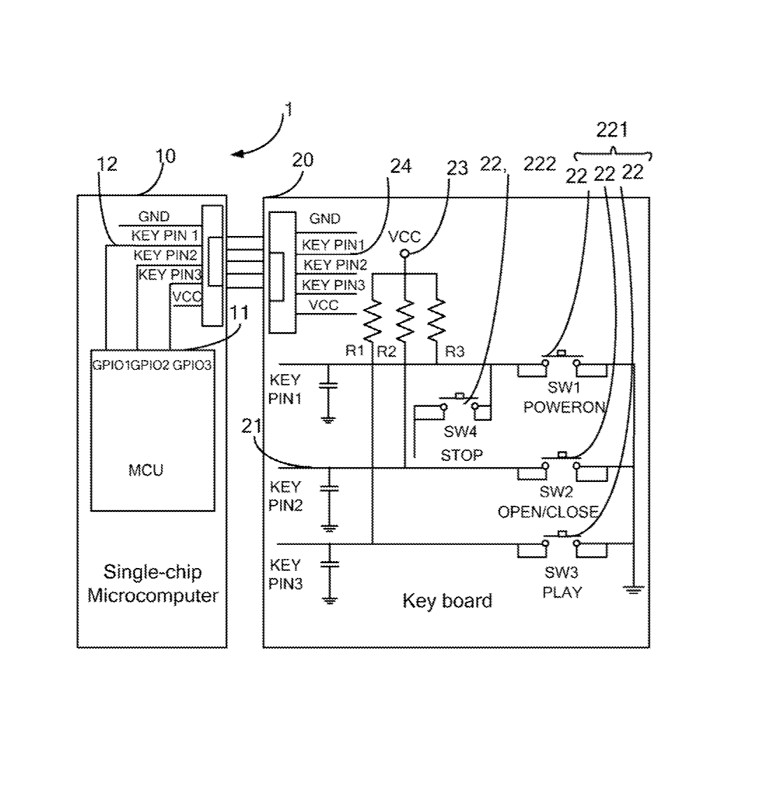

### BACKGROUND

1. Technical Field

The present disclosure relates to detection circuits and, more particularly, to a key detection circuit.

2. Description of Related Art

In a key detection circuit of related art, each general purpose input/output (GPIO) interface corresponds to one switch. However, when the number of the switches is large, the number of the corresponding GPIO interfaces will be also large, which increases the hardware cost. It is thus desirable to provide a new key detection circuit to resolve the above problem.

### BRIEF DESCRIPTION OF THE DRAWING

The components in the drawing are not necessarily drawn to scale, the emphasis instead being placed upon clearly illustrating the principles of the key detection circuit.

The drawing is a circuit diagram of a key detection circuit in accordance with an exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

Referring to the drawing, a key detection circuit 1 in accordance with an exemplary embodiment is shown. The circuit 1 includes a single-chip microcomputer 10 and a key board 20. In the embodiment, the single-chip microcomputer 10 is an Advanced RISC Machine (ARM) single-chip microcomputer. The single-chip microcomputer 10 includes a number of General Purpose Inputs/Outputs (GPIO) interfaces 11, for example GPIO1, GPIO2, and GPIO3. Each GPIO interface 11 is set to be an input port. One GPIO interface 11 is set to receive an input voltage which alternates between a high level and a low level (hereinafter, alternating input voltages), and the time interval of the alternating input voltages is less than the time of activation of the key board 20. The number of the GPIO interfaces 11 can be varied according to need, and the particular GPIO interface 11 which is to receive the alternating input voltages can be varied according to need. For example, within a first time interval, GPIO2 may be set to receive the alternating input voltages, and within a second time interval, it is GPIO3 which may be set to receive the alternating input voltages.

The key board 20 includes a number of key pins 21, a number of switches 22, and a power supply 23. Each key pin 21 corresponds to one GPIO interface 11, for example, KEY PIN1 corresponds to GPIO1, KEY PIN2 corresponds to GPIO2, and KEY PIN3 corresponds to GPIO3. When one switch 22 is closed (that is, a keyboard button is pressed), the key board 20 is activated. The switches 22 can be categorized into a first group of switches 221 and a second group of switches 222. Each switch 22 of the first group of switches 221 is connected to one key pin 21, for example, SW1, SW2, and SW3 are connected to one key pin 21. Each switch 22 of the second group of switches 222 is connected to two key pins 21, for example, SW4 is connected to two key pins 21. The GPIO interface 11 corresponding to one key pin 21 connected to one switch 22 of the second group of switches 222 is set to receive alternating input voltages. The number of switches 22 in the second group of switches 222 may be two or three, and each is connected between two key pins 21, for example, one switch 22 is connected between KEY PIN1 and KEY PIN2, and another switch 22 is connected between KEY PIN1 and KEY PIN3.

One end of each switch 22 of the first group of switches 221 is connected to the power supply 23, and the opposite end of each switch 22 of the first group of switches 221 is grounded. In the embodiment, one end of each switch 22 of the first group of switches 221 is connected to the power supply 23 through a resistor. As shown in the drawing, the power supply 23 is represented by VCC. An example in which the GPIO2 is set to receive alternating input voltages will be employed to illustrate the principle of present disclosure.

In an initial state, the power supply 23 provides a high level voltage to the GPIO1 and GPIO3, thus the GPIO1 and GPIO3 are at high level. The GPIO2 is set to receive alternating input voltages.

When SW1 is closed, the GPIO1 changes from high level to low level, the GPIO2 remains in the alternating input voltages mode, and the GPIO3 remains at high level. The single-chip microcomputer 10 reads the voltages of the GPIO1, GPIO2, and GPIO3, determines that SW1 is closed according to the read voltages, and executes an operation corresponding to SW1.

When SW2 is closed, the GPIO1 remains in high state, the GPIO2 changes to receive a low level voltage, and the GPIO3 remains in high level. The single-chip microcomputer 10 reads the voltages of GPIO1, GPIO2, and GPIO3, determines that SW2 is closed according to the read voltages, and executes an operation corresponding to SW2.

When SW3 is closed, the GPIO1 remains in high level, the GPIO2 remains in the alternating input voltages mode, and the GPIO3 changes from high level to low level. The single-chip microcomputer 10 reads the voltages of GPIO1, GPIO2, and GPIO3, determines that SW3 is closed according to the read voltages, and executes an operation corresponding to SW3.

When SW4 is closed, the GPIO1 and the GPIO2 are simultaneously at one level (either high level or low level), and the GPIO3 remains at high level. The single-chip microcomputer 10 reads the voltages of GPIO1, GPIO2, and GPIO3, determines that SW4 is closed according to the read voltages, and executes an operation corresponding to SW4.

In the embodiment, the single-chip microcomputer 10 includes a number of first interfaces 12. Each first interface 12 is connected to one GPIO interface 11. The key board 20 includes a number of second interfaces 24. Each second interface 24 is connected to one key pin 21. Each first interface 12 communicates with one second interface 24 via a wireless or a cable network.

In this configuration, the key detection circuit 1 employs a smaller number of GPIO interfaces 11 to detect the same number of switches 22, which decreases cost.

Although the current disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A key detection circuit comprising:
a plurality of key pins;
a plurality of switches comprising a first group of switches and a second group of switches, each one of the first group of switches being connected to one of the key pins, and each one of the second group of switches being connected to two of the key pins; and
a plurality of general purpose input/output (GPIO) interfaces, each of the GPIO interfaces corresponding to one of the key pins, one of the GPIO interfaces being set to receive input voltages which alternate between a high level and a low level, the other GPIO interfaces being set to receive a fixed level voltage input.

2. The key detection circuit as described in claim 1 further comprising a power supply, wherein one end of each switch of the first group of switches is connected to the power supply, and an opposite end of each switch of the first group of switches is grounded.

3. The key detection circuit as described in claim 1, wherein a time interval of the input voltages which alternates between the high level and the low level is less than the time of close of one switch.

4. The key detection circuit as described in claim 1, further comprising a single-chip microcomputer and a key board, wherein the single-chip microcomputer comprises the GPIO interfaces, the key board includes the key pins and the switches.

5. The key detection circuit as described in claim 4, wherein the single-chip microcomputer is an Advanced RISC Machine (ARM) single-chip microcomputer.

6. The key detection circuit as described in claim 4, wherein the single-chip microcomputer comprises a plurality of first interfaces, each of the first interfaces is connected to one of the GPIO interfaces, the key board comprises a plurality of second interfaces, each of the second interfaces is connected to one of the key pins, each of the first interfaces communicates with one of the second interfaces via a wireless or a cable network.
